(19) United States
(12) Patent Application Publication
(10) Pub. No.: US 2017/0091833 A1
(43) Pub. Date: Mar. 30, 2017

(54) GRAPHICAL RULE EDITOR

(71) Applicant: SAP SE, Walldorf (DE)

(72) Inventors: Franz-Dieter Berger, Saarbrucken (DE); Veronique Hinz, Moselle (FR); Patrick Simon, Beckingen (DE); Rudolf Wolfanger, Neunkirchen (DE)

(21) Appl. No.: 14/868,534

(22) Filed: Sep. 29, 2015

(51) Int. Cl. G06Q 30/02; G06F 3/0484; H04L 29/08

(52) U.S. Cl. CPC G06Q 30/0276; H04L 67/02; G06F 3/04842; G06F 3/04847

(57) ABSTRACT

A system includes a user interface simultaneously displaying an offer selection rule fragment area and a plurality of condition category rule fragment areas, and, in response to a first user selection of a first user interface control associated with the offer selection rule fragment area, displaying a plurality of offer selection rule fragments. The interface receives a second user selection of one of the plurality of offer selection rule fragments, and one or more parameters to associate with the selected rule fragment are received. The selected rule fragment of the selected offer selection rule fragment category and the associated one or more parameters are displayed in the offer selection rule fragment area of the user interface, and a selected rule fragment of a condition category and a second one or more parameters associated with the selected rule fragment of the condition category are displayed in the condition category rule fragment area of the user interface.

### BACKGROUND

Businesses attempt to increase sales by presenting offers to potential customers. These offers may be presented via conventional advertising channels such as print, radio, television, etc. The World Wide Web provides another medium for presenting offers to potential customers.

FIG. 1 illustrates Web page 100 of a fictional online shopping website. Web page 100 displays details of a product in product area 110, and allows a user to add the product to the user's online shopping cart via Add to Cart control 115. Web page 100 also includes offer area 120. Offer area 120 presents two offers to the user. The offers which are presented may be determined based on any number of factors and on any number of rules incorporating such factors.

These rules may be formulated by marketers, salespersons and other employees who are intimately familiar with products, customers and the relevant market. The rules must be implemented within the logic of a back-end application which generates and provides Web page 100. However, such employees typically do not possess programming skills required to create and edit the logic of a back-end application. Systems are desired to facilitate the intuitive creation of executable rules for determining offers to present to potential customers.

### BRIEF DESCRIPTION OF THE DRAWINGS

FIG. 1 is an outward view of a Web page of an online shopping website.

FIG. 2 is an outward view of a user interface according to some embodiments.

FIG. 3 is an outward view of a user interface according to some embodiments.

FIG. 4 is a block diagram of a system architecture according to some embodiments.

FIG. 5 is an outward view of a user interface according to some embodiments.

FIG. 6 is an outward view of a user interface according to some embodiments.

FIG. 7 is an outward view of a user interface according to some embodiments.

FIG. 8 is an outward view of a user interface according to some embodiments.

FIG. 9 is an outward view of a user interface according to some embodiments.

FIG. 10 is an outward view of a user interface according to some embodiments.

FIGS. 11A and 11B comprise a flow diagram of a process according to some embodiments.

FIG. 12 is a block diagram of an apparatus according to some embodiments.

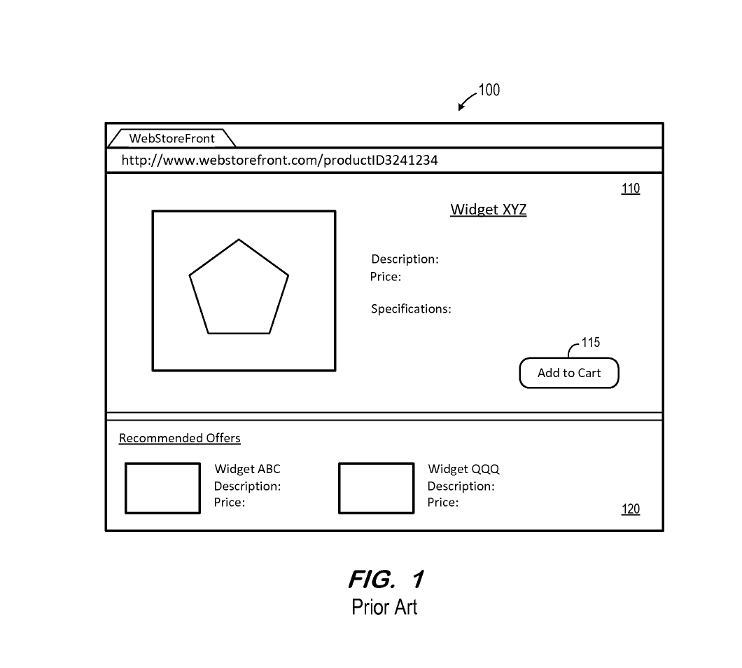

### DETAILED DESCRIPTION

The following description is provided to enable any person in the art to make and use the described embodiments. Various modifications, however, will remain readily apparent to those in the art.

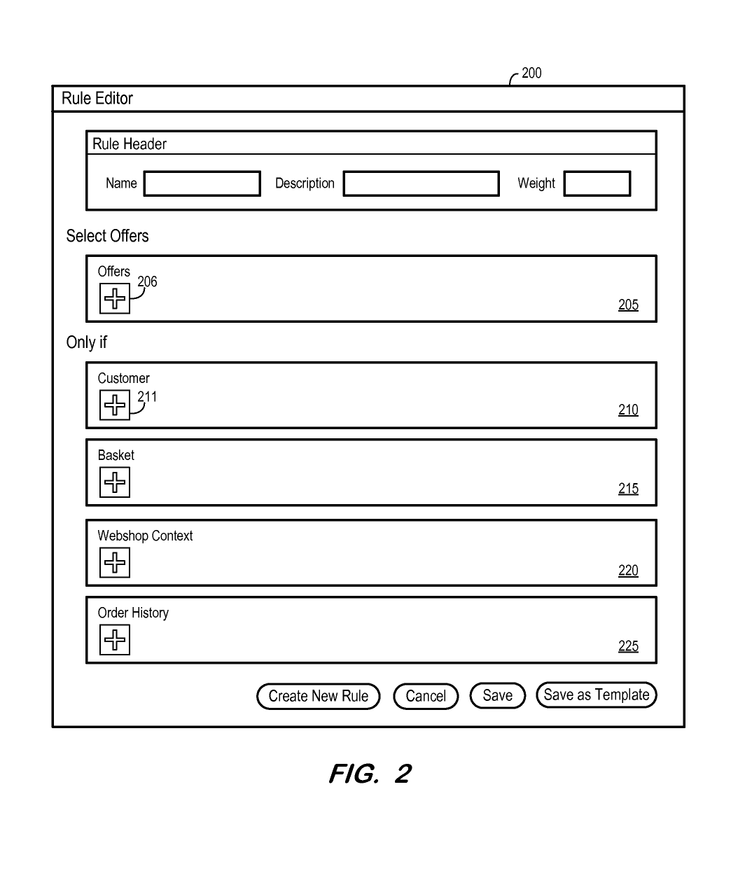

FIG. 2 is an outward view of user interface 200 according to some embodiments. User interface 200 may facilitate the generation of rules for presenting offers based on specified conditions.

User interface 200 may be presented on any type of display apparatus (e.g., desktop monitor, smartphone display, tablet display) provided by any type of client device (e.g., desktop system, smartphone, tablet computer). The application which is executed to provide user interface 200 may comprise a Web Browser, a standalone application, or any other application. Embodiments are not limited to user interface 200 of FIG. 2.

User interface 200 displays offer selection rule fragment area 205. Offer selection rule fragment area 205 is intended to display fragments of a rule which is evaluated to select offers from a group of pre-defined offers. An example of an offer selection rule may be: “all offers including product XYZ”. According to the description herein, “product ______” is referred to as a rule fragment and “XYZ” is a parameter associated with the rule fragment.

A rule may consist of one or more parameterized fragments. For example, another offer selection rule may be: “all offers including product XYZ where the offer price is less than $20”. This rule is composed of two parameterized rule fragments: “product XYZ” and “offer price is less than $20”. As will be described below, these parameterized rule fragments may be displayed in offer selection rule fragment area 205 so as to clearly portray a user-generated offer selection rule.

Offer selection rule fragment area 205 includes control 206. As will also be described in detail below, selection of control 206 may allow a user to select an offer selection rule fragment and a parameter to associate with the rule fragment.

Simultaneous with the display of offer selection rule fragment area 205, user interface 200 displays condition category rule fragment area 210, condition category rule fragment area 215, condition category rule fragment area 220, and condition category rule fragment area 225. Areas 210 through 225 allow a user to intuitively specify the conditions under which an offer will be selected by a rule displayed in offer selection rule fragment area 205.

Each condition category is associated with one or more rule fragments, and control 211 of condition category rule fragment area 210 may be selectable to allow a user to select a condition category, a rule fragment of the condition category, and one or more parameters to associate with the selected rule fragment. Examples of the foregoing operation will be provided below.

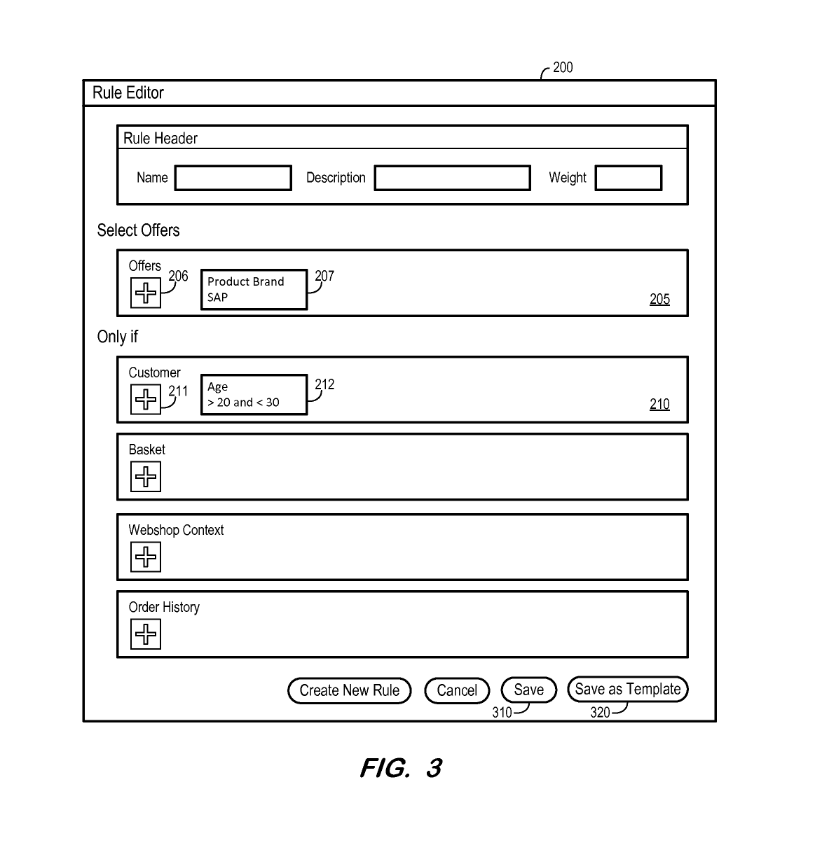

FIG. 3 illustrates user interface 200 after a user has selected control 206 to select offer selection rule fragment “Product Brand”, and associated parameter “SAP”. Offer selection rule fragment area 205 therefore displays icon 207 identifying the parameterized rule fragment.

Similarly, a user has selected control 211 of condition category rule fragment area 210 to select the condition category Customer, the rule fragment “Age”, and the associated parameters “is between”, “20” and “30”. Condition category rule fragment area 210 therefore displays icon 212 identifying the thusly-parameterized rule fragment.

User interface 200 of FIG. 3 therefore intuitively presents a rule to select all offers associated with the product brand SAP if the age of the prospective customer is between 20 and 30. The rule may be saved to a data store by selecting Save control 310. Selection of Save as Template control 320 results in saving the non-parameterized rule fragments of the rule (e.g., “product brand______ and age______”). User interface 200 also provides intuitive and efficient generation of such a rule according to some embodiments, as will be explained below.

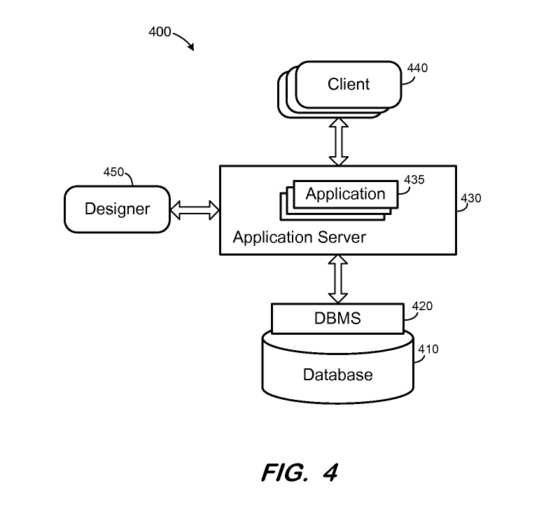

Prior to providing a detailed example of operation of user interface 200 according to some embodiments, an example of a hardware system implementing user interface 200 will now be described. FIG. 4 is a block diagram of system architecture 400 according to some embodiments. Embodiments are not limited to architecture 400 or to a three-tier database architecture.

Architecture 400 includes database 410, database management system (DBMS) 420, application server 430, applications 435, clients 440 and designer 450. Applications 435 may comprise server-side executable program code (e.g., compiled code, scripts, etc.) executing within application server 430 to receive queries from clients 440 and provides results to clients 440 based on data of database 410. One such application 435 may comprise an online shopping website. Applications 435 executing within application server 430 may also provide user interfaces to designer 450 to facilitate the creation of condition-based offer selection rules as described herein. These rules may be used by the aforementioned online shopping website to present offers to clients 440.

Application server 430 provides any suitable interfaces through which clients 440 and designer 450 may communicate with applications 435 executing on application server 430. For example, application server 430 may include a HyperText Transfer Protocol (HTTP) interface supporting a transient request/response protocol over Transmission Control Protocol/Internet Protocol (TCP/IP), a WebSocket interface supporting non-transient full-duplex communications which implement the WebSocket protocol over a single TCP/IP connection, and/or an Open Data Protocol (OData) interface.

One or more applications 435 executing on server 430 may communicate with DBMS 420 using database management interfaces such as, but not limited to, Open Database Connectivity (ODBC) and Java Database Connectivity (JDBC) interfaces. These types of applications 435 may use Structured Query Language (SQL) to manage and query data stored in database 410.

DBMS 420 serves requests to retrieve and/or modify data of database 410, and also performs administrative and management functions. Such functions may include snapshot and backup management, indexing, optimization, garbage collection, and/or any other database functions that are or become known. DBMS 420 may also provide application logic, such as database procedures and/or calculations, according to some embodiments. This application logic may comprise scripts, functional libraries and/or compiled program code.

Application server 430 may be separated from or closely integrated with DBMS 420. A closely-integrated application server 430 may enable execution of server applications 435 completely on the database platform, without the need for an additional application server. For example, according to some embodiments, application server 430 provides a comprehensive set of embedded services which provide end-to-end support for Web-based applications. The services may include a lightweight web server, configurable support for OData, server-side JavaScript execution and access to SQL and SQLScript.

Application server 430 may provide application services (e.g., via functional libraries) using which applications 435 may manage and query the data of database 410. The application services can be used to expose the database data model, with its tables, hierarchies, views and database procedures, to clients. In addition to exposing the data model, application server 430 may host system services such as a search service.

Database 410 may store data used by applications 435. Continuing with the online shopping example, database 410 may store product information (e.g., name, description, images, price, brand), customer information (e.g., name, location, age, order history), offer information (e.g., product(s), quantity, price) and/or any other data for providing an online shopping website. Database 410 may also store offer selection rule fragments, condition categories, condition category rule fragments, parameterized rules, and rule templates (e.g., each consisting of one or more non-parameterized rule fragments).

Database 410 may comprise any query-responsive data source or sources that are or become known, including but not limited to a structured-query language (SQL) relational database management system. Database 410 may comprise a relational database, a multi-dimensional database, an eXtendable Markup Language (XML) document, or any other data storage system storing structured and/or unstructured data. The data of database 410 may be distributed among several relational databases, dimensional databases, and/or other data sources. Embodiments are not limited to any number or types of data sources.

In some embodiments, the data of database 410 may comprise one or more of conventional tabular data, row-based data, column-based data, and object-based data. Moreover, the data may be indexed and/or selectively replicated in an index to allow fast searching and retrieval thereof. Database 410 may support multi-tenancy to separately support multiple unrelated clients by providing multiple logical database systems which are programmatically isolated from one another.

Database 410 may implement an “in-memory” database, in which a full database stored in volatile (e.g., non-disk-based) memory (e.g., Random Access Memory). The full database may be persisted in and/or backed up to fixed disks (not shown). Embodiments are not limited to an in-memory implementation. For example, data may be stored in Random Access Memory (e.g., cache memory for storing recently-used data) and one or more fixed disks (e.g., persistent memory for storing their respective portions of the full database).

Designer 450 and each of clients 440 may comprise one or more devices executing program code of a software application for presenting user interfaces to allow interaction with application server 430. Presentation of a user interface as described herein may comprise any degree or type of rendering, depending on the type of user interface code generated by application server 430.

For example, a client 440 may execute a Web Browser to request and receive a Web page (e.g., in HTML format) from a website application 435 of application server 430 via HTTP, HTTPS, and/or WebSocket, and may render and present the Web page according to known protocols. One or more of clients 440 may also or alternatively present user interfaces by executing a standalone executable file (e.g., an .exe file) or code (e.g., a JAVA applet) within a virtual machine. In one example, designer 450 executes an application supporting a WebUI protocol to communicate with a rule designer application 435 of application server 430 via OData.

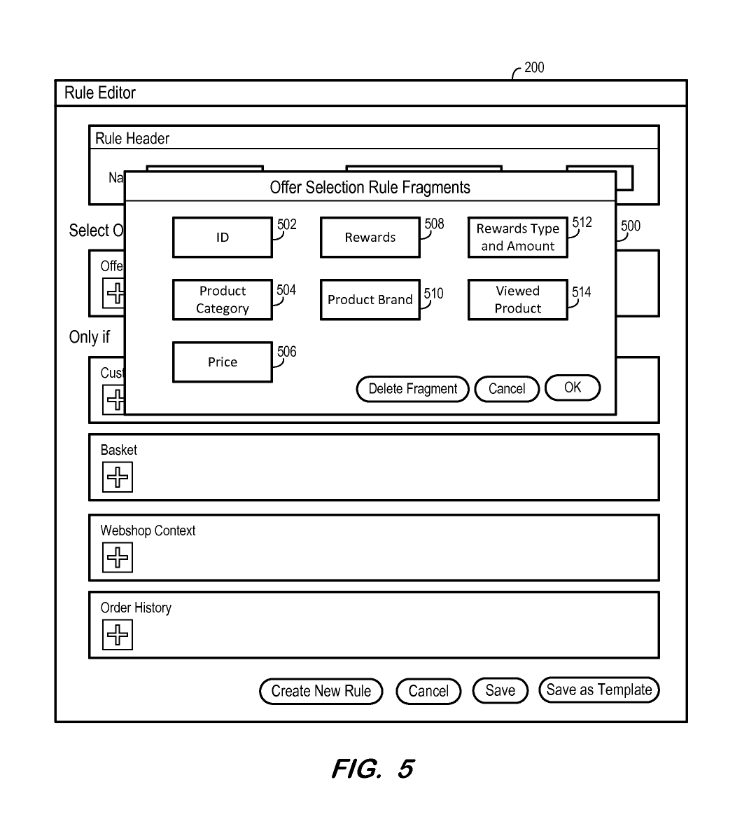

Returning to the example of user interface 200, FIG. 5 illustrates window 500 superimposed on user interface 200. According to some embodiments, window 500 is displayed in response to user selection of control 206 of offer selection rule fragment area 205.

Window 500 presents UI controls 502 through 514, each of which specifies a respective offer selection rule fragment. Embodiments are not limited to the fragments of window 500. Each of UI controls 502 through 514 is selectable to result in presentation of an offer rule selection fragment associated with the selected control. As an illustrative example, it will be assumed that Product Brand control 510 is selected.

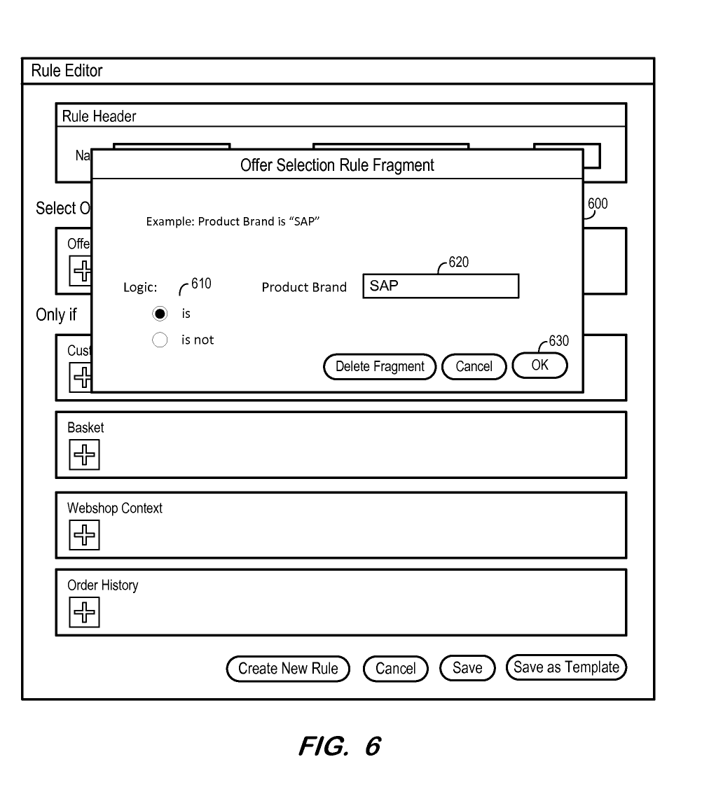

FIG. 6 illustrates window 600, which is displayed in response to selection of Product Brand control 510 according to some embodiments. Window 600 presents the Product Brand offer selection rule fragment, and is superimposed on user interface 200. Radio buttons 610 allow a user to select a logical parameter to associate with the rule fragment (i.e., “is” or “is not”) and field 620 allows a user to associate a text parameter (i.e., a specific product brand) with the rule fragment. The parameterized rule fragment is saved (e.g., to database 430) upon selection of OK control 630.

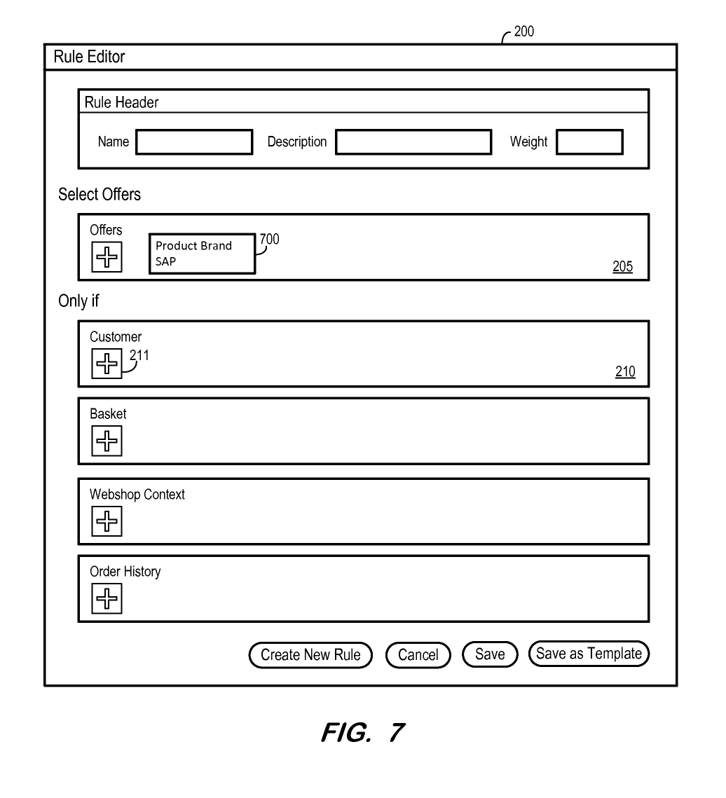

FIG. 7 shows user interface 200 after selection of OK control 630 of FIG. 6. In response to the data input to window 600 and the selection of OK button 630, user interface 200 now displays icon 700 in offer selection rule fragment area 205. Icon 700 depicts a rule fragment of a rule to select offers according to some embodiments. If the Save control of user interface 200 of FIG. 7 were selected, the saved rule would select all offers associated with the product brand “SAP”, with no conditions.

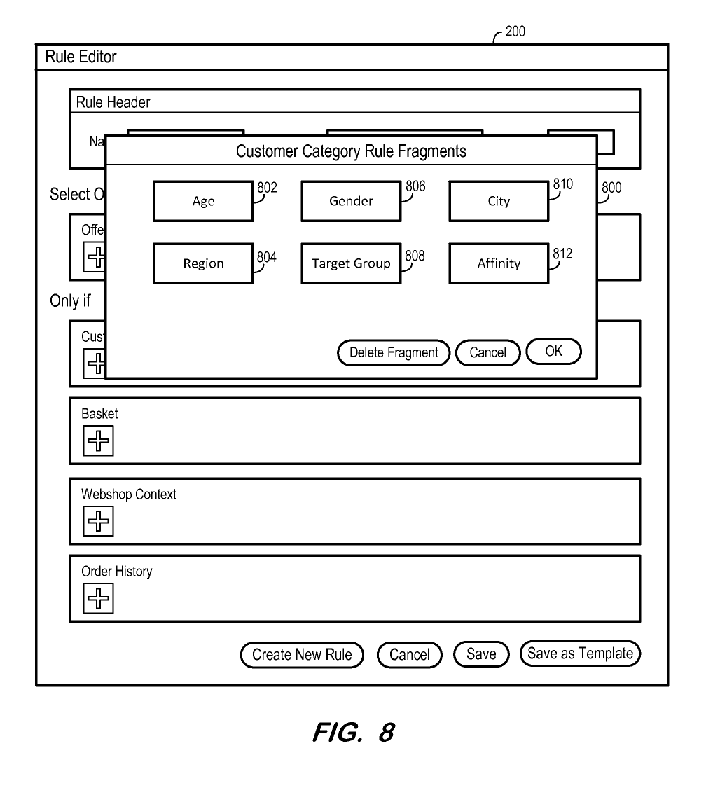

In this regard, it will now be assumed that the user selects Customer control 211 of Customer condition rule fragment area 210. In response, window 800 may be displayed as illustrated in FIG. 8. Window 800 presents UI controls 802 through 812, each of which specifies a respective rule fragment of the Customer rule fragment category. Embodiments are not limited to the rule fragments of window 800. Each of UI controls 802 through 812 is selectable to result in presentation of a rule fragment associated with the selected control. It will be assumed that Age control 802 is now selected.

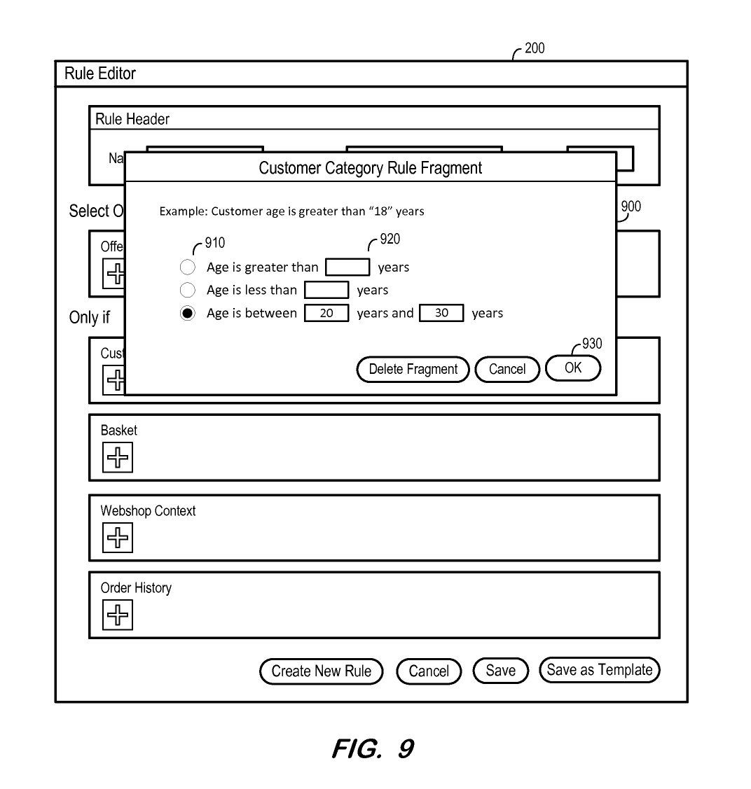

Window 900 of FIG. 9 may be is displayed in response to selection of Age control 802 according to some embodiments. Window 900 is superimposed on user interface 200 and presents the Age rule fragment. Embodiments are not limited to the rule fragments of window 900. Radio buttons 910 allow a user to select logical parameters to associate with the rule fragment and fields 920 are provided to associate one or more numerical parameters with the rule fragment. After a user selects a logical parameter and populates its corresponding field(s) 920 with a numerical parameter, the user may select OK control 930 to save the thusly-parameterized rule fragment.

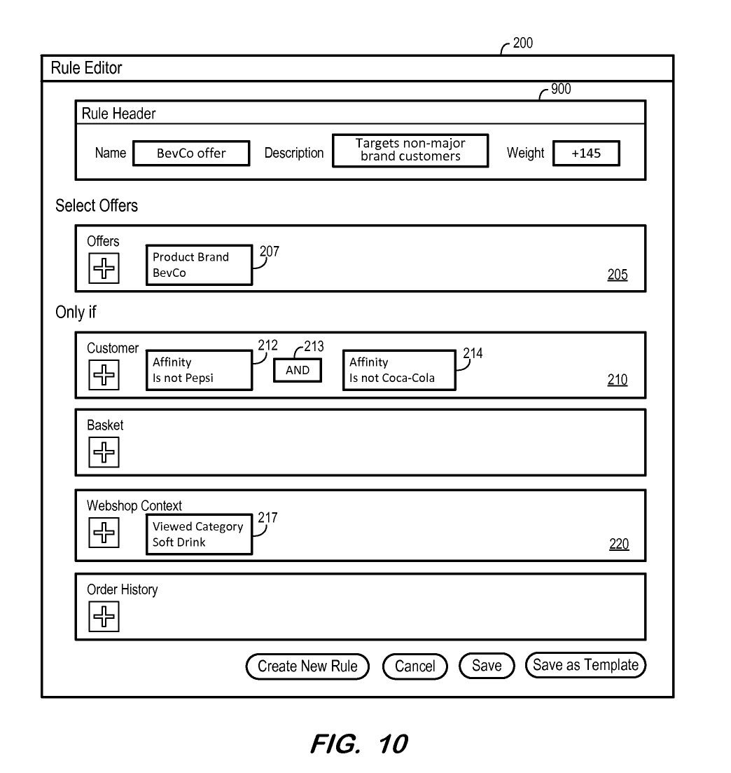

FIG. 10 illustrates user interface 200 after several rule fragments have been parameterized and saved as described above. User interface 200 displays icon 700 in offer selection rule fragment area 205, icons 212 and 214 in condition category rule fragment area 210, and icon 217 in condition category rule fragment area 220. A Boolean operator icon 213 is provided in area 212 because more than one rule fragment is represented in area 212. According to one embodiment, a user may select icon 213 to toggle between two or more different operators. For example, clicking on icon 213 as shown in FIG. 10 would cause icon 213 to display the OR operator, and clicking again on icon 213 would cause icon 213 to display the AND operator.

User interface 200 of FIG. 10 therefore displays a rule having the following logic: “Select all offers including products of the Brand “BevCo” only if the Customer is not associated with an Affinity for “Pepsi” and is not associated with an Affinity for “Coca-Cola” and is viewing the “Soft Drink” Category.

Rule header area 900 includes fields which allow a user to associate metadata with the displayed rule. These fields include the rule Name, a Description of the rule, and a Weight. The weight associated with a rule may be used to determine which of several candidate offers to select.

For example, a first rule may be evaluated to select several offers. Each of these selected offers is assigned points equal to the weight of the first rule. A second rule may be evaluated to select some other offers, each of which is assigned points equal to the weight of the second rule. Some offers may therefore be assigned points based on two or more rules. The offers associated with the most points are presented.

The rule (e.g., the rule fragments, Boolean operators, parameters and header metadata) may be saved by selecting the Save control of user interface 200. Upon selecting the Save as Template control of user interface 200, the rule may be saved in unparameterized format (e.g., Select all offers associated with Product Brand “______” only if the Customer “(is/is not)” associated with an Affinity for “______” and “(is/is not)” associated with an Affinity for “______” and is viewing the “______” Category).

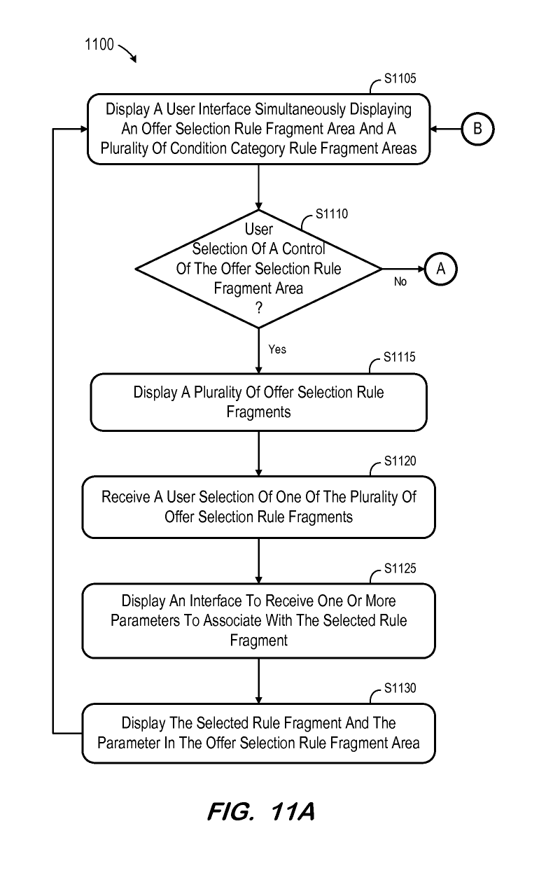

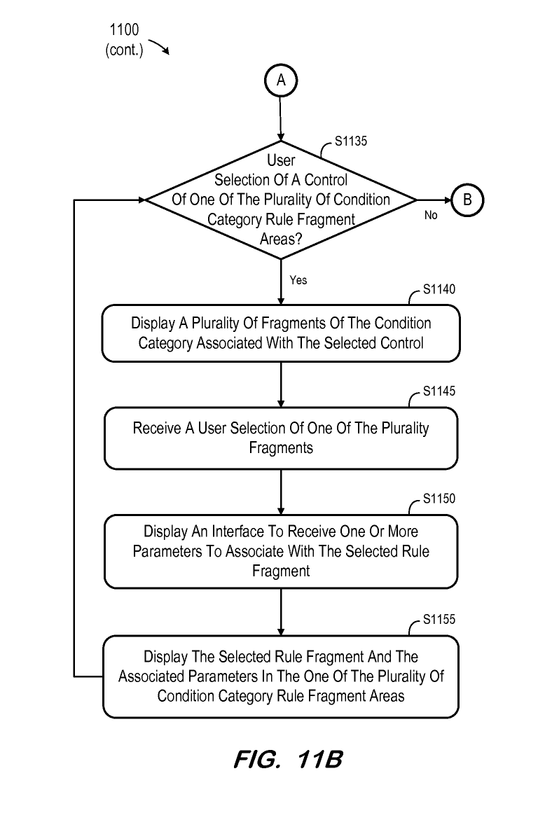

FIGS. 11A and 11B comprises a flow diagram of process 1100 according to some embodiments. Process 1100 may facilitate the creation and presentation of condition-based offer selection rules according to some embodiments.

In some embodiments, various hardware elements of architecture 400 (e.g., one or more processors) execute program code to perform process 1100. Process 1100 and all other processes mentioned herein may be embodied in processor-executable program code read from one or more of non-transitory computer-readable media, such as a floppy disk, a disk-based or solid-state hard drive, CD-ROM, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Initially, a user interface is displayed at S1105. The user interface simultaneously displays an offer selection rule fragment area (e.g., area 205 of user interface 200) and a plurality of condition category rule fragment areas (e.g., areas 210-225 of user interface 200). As described above, the user interface may be displayed by a computing system operated by a rule designer, in response to a designer application executed by the computing system or executed by a remote computing system in communication with the computing system.

At S1110, it is determined whether the user has selected a control displayed within the offer selection rule fragment area. An example of such a control is control 206 displayed within area 205. If such a control is selected, a plurality of offer selection rule fragments is displayed at S1115, for example as described with respect to FIG. 5.

A user selection of one of the plurality of offer selection rule fragments is received at S1120. In one example, and again with reference to the above description, the displayed offer selection rule fragment Product Brand of FIG. 5 may be selected at S1120.

Next, at S1125, an interface is displayed to receive one or more parameters to associate with the rule fragment. Examples of such an interface and received parameters are provided in FIG. 6 and described above.

The selected offer selection rule fragment and the parameter(s) are displayed at S1130 in the offer selection rule fragment area. FIGS. 3, 7 and 10 each illustrate display of an offer selection rule fragment and associated parameter in offer selection rule fragment area 205.

Returning to S1110, flow proceeds to S1135 if no user selection of a control of the offer selection rule fragment area is detected. At S1135, it is determined whether the user has selected a control of one of the plurality of condition category rule fragment areas displayed in the user interface. If not, flow returns to S1105. Accordingly, flow cycles between S1105, S1110 and S1135 while waiting for user selection of a control. Although not depicted in process 1100, this cycling may be terminated upon closing of the user interface, and/or selection of various other controls of the user interface such as, for example, the Create New Rule, Cancel, Save, and Save Template controls of user interface 200. It is noted that each created rule should include at least one offer selection rule fragment.

Flow proceeds from S1135 to S1140 in response to user selection of a control of one of the plurality of condition category rule fragment areas. As illustrated in FIG. 8 and described above, user selection of such a control (e.g., control 211) results in display of a plurality of fragments of the condition category (e.g., Customer) associated with the selected control at S1140. A user selection of one of the fragments is received at S1145 and, in response, an interface is displayed at S1150. The interface displayed at S1150 is to receive one or more parameters to associate with the selected rule fragment.

As illustrated in FIG. 9, selection of subcategory 802 results in display of window 900. Window 900 presents the selected rule fragment and controls to receive associated parameters.

The selected rule fragment and its associated parameter(s) are displayed in the condition category rule fragment area of the control selected at S1135. As described above, FIGS. 3 and 10 provide examples of several displayed rule fragments and associated parameters displayed in their respective condition category rule fragment area.

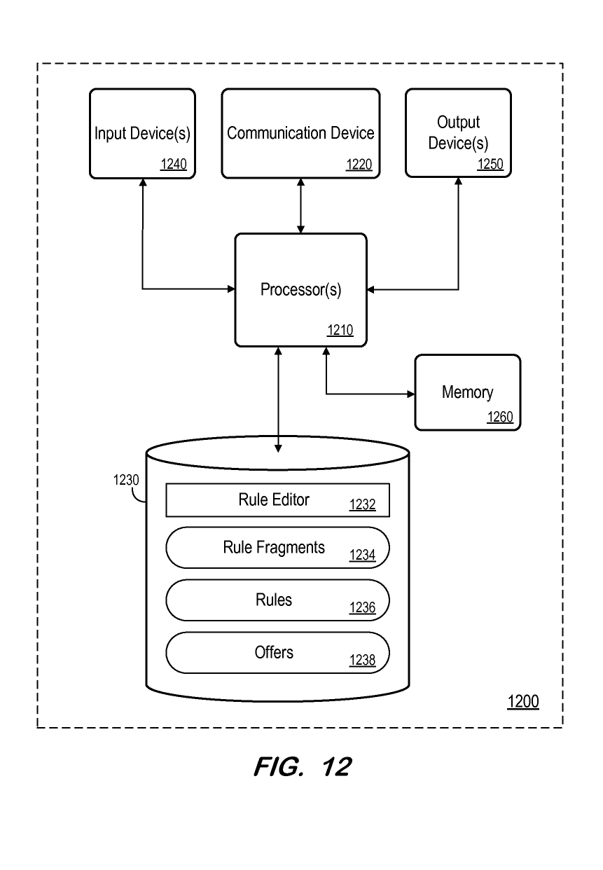

FIG. 12 is a block diagram of apparatus 1200 according to some embodiments. Apparatus 1200 may comprise a general-purpose computing apparatus and may execute program code to perform any of the functions described herein. According to some embodiments, apparatus 1200 may comprise an implementation of application server 430, DBMS 420 and database 410 of FIG. 4. Apparatus 1200 may also comprise a standalone computing device. Apparatus 1200 may include other unshown elements.

Apparatus 1200 includes processor(s) 1210 operatively coupled to communication device 1220, data storage device 1230, one or more input devices 1240, one or more output devices 1250 and memory 1260. Communication device 1220 may facilitate communication with external devices, such as a client, a designer, or an external data storage device. Input device(s) 1240 may comprise, for example, a keyboard, a keypad, a mouse or other pointing device, a microphone, knob or a switch, an infra-red (IR) port, a docking station, and/or a touch screen. Input device(s) 1240 may be used, for example, to enter information into apparatus 1200. Output device(s) 1250 may comprise, for example, a display (e.g., a display screen) a speaker, and/or a printer.

Data storage device 1230 may comprise any appropriate persistent storage device, including combinations of magnetic storage devices (e.g., magnetic tape, hard disk drives and flash memory), optical storage devices, Read Only Memory (ROM) devices, etc., while memory 1260 may comprise Random Access Memory (RAM), Storage Class Memory (SCM) or any other fast-access memory.

Rule editor 1232 may comprise program code executed by processor(s) 1210 to cause apparatus 1200 to perform any one or more of the processes described herein, including but not limited to process 1100. Embodiments are not limited to execution of these processes by a single apparatus.

Rule fragments 1234, rules 1236 and offers 1238 may be stored in device 1230 as shown and/or in volatile memory such as memory 1260. As described above, rule fragments 1234 may comprise unparameterized offer selection rule fragments and unparameterized rule fragments of condition categories, and rules 1236 may each comprise a combination of parameterized rule fragments joined by Boolean statements. A rule designer may design one or more of rules 1236 using rule fragments 1234 and the user interfaces and processes described herein. Rules 1236 may also comprise unparameterized rules, or templates as referred to above. Offers 1238 may include product offers which are selectable via execution of offer selection rules composed of parameterized rule fragments as described herein. Data storage device 1230 may also store data and other program code for providing additional functionality and/or which are necessary for operation of apparatus 1200, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A system comprising:
a display;
a memory storing processor-executable process steps; and
a processor to execute the processor-executable process steps to cause the system to:
display a user interface on the display, the user interface simultaneously displaying an offer selection rule fragment area and a plurality of condition category rule fragment areas;
in response to a first user selection of a first user interface control associated with the offer selection rule fragment area, display a plurality of offer selection rule fragments;
receive a second user selection of one of the plurality of offer selection rule fragments;
display, on the display, an interface to receive one or more parameters to associate with the selected rule fragment;
display, on the display, the selected rule fragment of the selected offer selection rule fragment category and the associated one or more parameters in the offer selection rule fragment area of the user interface;
in response to a fourth user selection of a second user interface control associated with one of the plurality of condition category rule fragment areas, display, on the display, a plurality of rule fragments of a condition category associated with the one of the plurality of condition categories;
receive a fifth user selection of one of the plurality of rule fragments of the condition category;
display, on the display, an interface to receive a sixth user selection of a second one or more parameters to associate with the selected rule fragment of the condition category; and
display, on the display, the selected rule fragment of the selected condition category and the second one or more parameters associated with the selected rule fragment of the condition category in the condition category rule fragment area of the user interface.

2. A system according to claim 1, wherein the processor is further to execute the processor-executable process steps to cause the system to:
in response to a seventh user selection of the first user interface control associated with the offer selection rule fragment area, display, on the display, the plurality of offer selection rule fragments;
receive an eighth user selection of a second one of the plurality of offer selection rule fragments;
display, on the display, an interface to receive a third one or more parameters to associate with the selected second one of the plurality of offer selection rule fragments; and
display, on the display, the selected second one of the plurality of offer selection rule fragments and the third one or more associated parameters in the offer selection rule fragment area of the user interface.

3. A system according to claim 2, wherein the processor is further to execute the processor-executable process steps to cause the system to:
display, on the display, a Boolean operator between the displayed selected rule fragment and the displayed selected second one of the plurality of offer selection rule fragments.

4. A system according to claim 2, wherein the processor is further to execute the processor-executable process steps to cause the system to:
in response to a tenth user selection of the second user interface control associated with the one of the plurality of condition category rule fragment areas, display, on the display, the second plurality of rule fragments associated with the condition category;
receive an eleventh user selection of one of the second plurality of rule fragments;
display, on the display, an interface to receive a twelfth user selection of a fourth one or more parameters to associate with the selected rule fragment of the selected second one of the plurality of sub-categories; and
display, on the display, the selected rule fragment of the selected one of the second plurality of rule fragments and the fourth one or more parameters in the condition category rule fragment area of the user interface.

5. A system according to claim 4, wherein the processor is further to execute the processor-executable process steps to cause the system to:
in response to a thirteenth user selection of a third user interface control associated with a second one of the plurality of condition category rule fragment areas, display, on the display, a second plurality of rule fragments of a second condition category;
receive an fourteenth user selection of one of the second plurality of rule fragments of the second condition category;
display, on the display, an interface to receive a fifth one or more parameters to associate with the selected rule fragment of the one of the second plurality of rule fragments of the second condition category; and
display, on the display, the selected rule fragment of the one of the second plurality of rule fragments of the second condition category and the fifth one or more parameters in the second one of the plurality of condition category rule fragment areas of the user interface.

6. A system according to claim 1, wherein the processor is further to execute the processor-executable process steps to cause the system to:
in response to a seventh user selection of a third user interface control associated with a second one of the plurality of condition category rule fragment areas, display, on the display, a second plurality of rule fragments of a second condition category;
receive an eighth user selection of one of the second plurality of rule fragments of the second condition category;
display, on the display, an interface to receive a ninth user selection of a third one or more parameters to associate with the selected one of the second plurality of rule fragments of the second condition category; and
display, on the display, the selected one of the second plurality of rule fragments of the second condition category and the third one or more parameters in the second one of the plurality of condition category rule fragment areas of the user interface.

7. A system according to claim 1, wherein the processor is further to execute the processor-executable process steps to cause the system to:
in response to a seventh user selection of the second user interface control associated with the one of the plurality of condition category rule fragment areas, display, on the display, the plurality of rule fragments of the condition category;
receive an eighth user selection of a second one of the plurality of rule fragments of the condition category;
display, on the display, an interface to receive a third one or more parameters to associate with the selected second one of the plurality of rule fragments of the condition category; and
display, on the display, the selected second one of the plurality of rule fragments of the condition category and the third one or more parameters in the condition category rule fragment area of the user interface.

8. A computer-implemented method comprising:
displaying a user interface on a display, the user interface simultaneously displaying an offer selection rule fragment area and a plurality of condition category rule fragment areas;
in response to a first user selection of a first user interface control associated with the offer selection rule fragment area, displaying a plurality of offer selection rule fragments;
receiving a second user selection of one of the plurality of offer selection rule fragments;
displaying, on the display, an interface to receive one or more parameters to associate with the selected rule fragment;
displaying, on the display, the selected rule fragment of the selected offer selection rule fragment category and the associated one or more parameters in the offer selection rule fragment area of the user interface;
in response to a fourth user selection of a second user interface control associated with one of the plurality of condition category rule fragment areas, displaying, on the display, a plurality of rule fragments of a condition category associated with the one of the plurality of condition categories;
receiving a fifth user selection of one of the plurality of rule fragments of the condition category;
displaying, on the display, an interface to receive a sixth user selection of a second one or more parameters to associate with the selected rule fragment of the condition category; and
displaying, on the display, the selected rule fragment of the selected condition category and the second one or more parameters associated with the selected rule fragment of the condition category in the condition category rule fragment area of the user interface.

9. A method according to claim 8, further comprising:
in response to a seventh user selection of the first user interface control associated with the offer selection rule fragment area, displaying, on the display, the plurality of offer selection rule fragments;
receiving an eighth user selection of a second one of the plurality of offer selection rule fragments;
displaying, on the display, an interface to receive a third one or more parameters to associate with the selected second one of the plurality of offer selection rule fragments; and
displaying, on the display, the selected second one of the plurality of offer selection rule fragments and the third one or more associated parameters in the offer selection rule fragment area of the user interface.

10. A method according to claim 9, further comprising:
displaying, on the display, a Boolean operator between the displayed selected rule fragment and the displayed selected second one of the plurality of offer selection rule fragments.

11. A method according to claim 9, further comprising:
in response to a tenth user selection of the second user interface control associated with the one of the plurality of condition category rule fragment areas, displaying, on the display, the second plurality of rule fragments associated with the condition category;
receiving an eleventh user selection of one of the second plurality of rule fragments;
displaying, on the display, an interface to receive a twelfth user selection of a fourth one or more parameters to associate with the selected rule fragment of the selected second one of the plurality of sub-categories; and
displaying, on the display, the selected rule fragment of the selected one of the second plurality of rule fragments and the fourth one or more parameters in the condition category rule fragment area of the user interface.

12. A method according to claim 11, further comprising:
in response to a thirteenth user selection of a third user interface control associated with a second one of the plurality of condition category rule fragment areas, displaying, on the display, a second plurality of rule fragments of a second condition category;
receiving an fourteenth user selection of one of the second plurality of rule fragments of the second condition category;
displaying, on the display, an interface to receive a fifth one or more parameters to associate with the selected rule fragment of the one of the second plurality of rule fragments of the second condition category; and
displaying, on the display, the selected rule fragment of the one of the second plurality of rule fragments of the second condition category and the fifth one or more parameters in the second one of the plurality of condition category rule fragment areas of the user interface.

13. A method according to claim 8, further comprising:
in response to a seventh user selection of a third user interface control associated with a second one of the plurality of condition category rule fragment areas, displaying, on the display, a second plurality of rule fragments of a second condition category;
receiving an eighth user selection of one of the second plurality of rule fragments of the second condition category;
displaying, on the display, an interface to receive a ninth user selection of a third one or more parameters to associate with the selected one of the second plurality of rule fragments of the second condition category; and
displaying, on the display, the selected one of the second plurality of rule fragments of the second condition category and the third one or more parameters in the second one of the plurality of condition category rule fragment areas of the user interface.

14. A method according to claim 8, further comprising:
in response to a seventh user selection of the second user interface control associated with the one of the plurality of condition category rule fragment areas, displaying, on the display, the plurality of rule fragments of the condition category;
receiving an eighth user selection of a second one of the plurality of rule fragments of the condition category;
displaying, on the display, an interface to receive a third one or more parameters to associate with the selected second one of the plurality of rule fragments of the condition category; and
displaying, on the display, the selected second one of the plurality of rule fragments of the condition category and the third one or more parameters in the condition category rule fragment area of the user interface.

15. A non-transitory computer-readable medium storing program code, the program code executable by a computer system to cause the computer system to:
displaying a user interface on a display, the user interface simultaneously displaying an offer selection rule fragment area and a plurality of condition category rule fragment areas;
in response to a first user selection of a first user interface control associated with the offer selection rule fragment area, displaying a plurality of offer selection rule fragments;
receiving a second user selection of one of the plurality of offer selection rule fragments;
displaying, on the display, an interface to receive one or more parameters to associate with the selected rule fragment;
displaying, on the display, the selected rule fragment of the selected offer selection rule fragment category and the associated one or more parameters in the offer selection rule fragment area of the user interface;
in response to a fourth user selection of a second user interface control associated with one of the plurality of condition category rule fragment areas, displaying, on the display, a plurality of rule fragments of a condition category associated with the one of the plurality of condition categories;
receiving a fifth user selection of one of the plurality of rule fragments of the condition category;
displaying, on the display, an interface to receive a sixth user selection of a second one or more parameters to associate with the selected rule fragment of the condition category; and
displaying, on the display, the selected rule fragment of the selected condition category and the second one or more parameters associated with the selected rule fragment of the condition category in the condition category rule fragment area of the user interface.

16. A medium according to claim 15, wherein the program code is further executable by the computer system to cause the computer system to:
in response to a seventh user selection of the first user interface control associated with the offer selection rule fragment area, displaying, on the display, the plurality of offer selection rule fragments;
receiving an eighth user selection of a second one of the plurality of offer selection rule fragments;
displaying, on the display, an interface to receive a third one or more parameters to associate with the selected second one of the plurality of offer selection rule fragments; and
displaying, on the display, the selected second one of the plurality of offer selection rule fragments and the third one or more associated parameters in the offer selection rule fragment area of the user interface.

17. A medium according to claim 16, wherein the program code is further executable by the computer system to cause the computer system to:
in response to a tenth user selection of the second user interface control associated with the one of the plurality of condition category rule fragment areas, displaying, on the display, the second plurality of rule fragments associated with the condition category;
receiving an eleventh user selection of one of the second plurality of rule fragments;
displaying, on the display, an interface to receive a twelfth user selection of a fourth one or more parameters to associate with the selected rule fragment of the selected second one of the plurality of sub-categories; and
displaying, on the display, the selected rule fragment of the selected one of the second plurality of rule fragments and the fourth one or more parameters in the condition category rule fragment area of the user interface.

18. A medium according to claim 17, wherein the program code is further executable by the computer system to cause the computer system to:
in response to a thirteenth user selection of a third user interface control associated with a second one of the plurality of condition category rule fragment areas, displaying, on the display, a second plurality of rule fragments of a second condition category;
receiving an fourteenth user selection of one of the second plurality of rule fragments of the second condition category;
displaying, on the display, an interface to receive a fifth one or more parameters to associate with the selected rule fragment of the one of the second plurality of rule fragments of the second condition category; and
displaying, on the display, the selected rule fragment of the one of the second plurality of rule fragments of the second condition category and the fifth one or more parameters in the second one of the plurality of condition category rule fragment areas of the user interface.

19. A medium according to claim 15, wherein the program code is further executable by the computer system to cause the computer system to:
in response to a seventh user selection of a third user interface control associated with a second one of the plurality of condition category rule fragment areas, displaying, on the display, a second plurality of rule fragments of a second condition category;
receiving an eighth user selection of one of the second plurality of rule fragments of the second condition category;
displaying, on the display, an interface to receive a ninth user selection of a third one or more parameters to associate with the selected one of the second plurality of rule fragments of the second condition category; and
displaying, on the display, the selected one of the second plurality of rule fragments of the second condition category and the third one or more parameters in the second one of the plurality of condition category rule fragment areas of the user interface.

20. A medium according to claim 15, wherein the program code is further executable by the computer system to cause the computer system to:
in response to a seventh user selection of the second user interface control associated with the one of the plurality of condition category rule fragment areas, displaying, on the display, the plurality of rule fragments of the condition category;
receiving an eighth user selection of a second one of the plurality of rule fragments of the condition category;
displaying, on the display, an interface to receive a third one or more parameters to associate with the selected second one of the plurality of rule fragments of the condition category; and
displaying, on the display, the selected second one of the plurality of rule fragments of the condition category and the third one or more parameters in the condition category rule fragment area of the user interface.
